(19) United States
(12) Patent Application Publication
(10) Pub. No.: US 2026/0016308 A1
(43) Pub. Date: Jan. 15, 2026

(54) SYSTEMS AND METHODS FOR DETERMINING ROUTINE AND OPTIMIZING CHARGING OF A VEHICLE

(71) Applicant: Ford Global Technologies, LLC, Dearborn, MI (US)

(72) Inventors: Mahmood Tabesh, Northville, MI (US); Ahmadreza Mahmoudzadeh, League City, TX (US); Hossein Sartipizadeh, Centennial, CO (US); Ryan O'Gorman, Beverly Hills, MI (US)

(73) Assignee: Ford Global Technologies, LLC, Dearborn, MI (US)

(21) Appl. No.: 18/770,175

(22) Filed: Jul. 11, 2024

(51) Int. Cl. G01C 21/34; B60L 58/12; B60L 58/16; G01C 21/36

(52) U.S. Cl. CPC G01C 21/3484; B60L 58/12; B60L 58/16; G01C 21/3469; G01C 21/3679

(57) ABSTRACT

A charging management system including a transceiver and a processor is disclosed. The transceiver may receive historical inputs associated with a vehicle. The processor may obtain the historical inputs from the transceiver, and determine a routine travel behavior of the vehicle based on the historical inputs. The processor may further determine a parking and charging location associated with the vehicle based on the routine travel behavior, and estimate a future departure time from the parking and charging location and a future arrival time at the primary parking and charging location based on the routine travel behavior. The processor may further estimate an amount of energy required by the vehicle to travel between the future departure time and the future arrival time based on the routine travel behavior, and perform a predetermined action based on the estimated amount of energy.

### FIELD

The present disclosure relates to electric vehicles (EV), and more particularly, to systems and methods for determining a routine and optimizing charging of a vehicle.

### BACKGROUND

With increasing number of electric vehicles (EVs), the EV landscape is rapidly evolving. An EV operates on electric energy, and a vehicle user is required to charge the vehicle battery regularly to ensure uninterrupted vehicle operation. The vehicle user may charge the EV at the user's home or at public charging stations. It is known that an EV has distinctive attributes such as restricted range and prolonged charging times, which may sometimes interrupt user's daily schedule, and may cause inconvenience to the user.

Thus, there exists a need for a system and method that may facilitate optimal vehicle charging, and enhance user experience to charge and use the EV.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts example snapshots of Parking Probability Profiles (PPP) of a vehicle on different days, in accordance with the present disclosure.

FIG. 3 depicts an example single PPP graph in accordance with the present disclosure.

FIG. 4 depicts an example process to optimize vehicle charging, in accordance with the present disclosure.

FIG. 5 depicts a flow diagram of an example vehicle charging method in accordance with the present disclosure.

### DETAILED DESCRIPTION

### Overview

The present disclosure describes a system that may determine a routine travel behavior of a vehicle (e.g., an electric vehicle), and estimate energy required to complete a vehicle routine. The system may then predict whether the vehicle may have sufficient battery charge to prevent interruption in the vehicle's daily routine/schedule. Responsive to determining that the vehicle may not have sufficient battery charge, the system may perform one or more predetermined actions (e.g., scheduling vehicle charging) to facilitate optimized vehicle charging.

In some aspects, the system may obtain historical inputs associated with the vehicle, and determine the routine travel behavior of the vehicle based on the historical inputs. The routine travel behavior may include, for example, a charging pattern, a parking pattern, a travel pattern, and/or the like associated with the vehicle. As an example, the system may determine charging locations/times at which the vehicle typically gets charged, parking locations/times at which the vehicle is typically parked, travel locations/times to/at which the vehicle typically travels, and/or the like. In addition, routine travel behavior may include travel frequency, travel route, energy consumption pattern, etc., associated with the vehicle.

Responsive to determining the routine travel behavior, the system may determine most visited locations and their respective visited time slots for the vehicle based on the routine travel behavior. The system may then determine a parking and charging location (e.g., a primary parking and charging location at which the vehicle spends the most time in the park state and/or in the charging state) associated with the vehicle 102 (e.g., a user home) from the most visited locations. Responsive to determining the parking and charging location, the system may estimate a future departure time from the parking and charging location and a future arrival time at the parking and charging location of the vehicle for the next day (or next week or next month), based on the routine travel behavior. In some aspects, the system may estimate the future departure time and future arrival time associated with non-primary parking and charging location as well, in addition to estimating them for the primary parking and charging location.

Based on determining the future departure time and the future arrival time, the system may estimate an amount of energy required by the vehicle to travel between the future departure time and the future arrival time on the next day (as an example), based on the routine travel behavior, and then perform one or more predetermined actions based on the estimated amount of energy.

The predetermined actions may include, for example, determining a requirement of additional energy for the vehicle battery between the future departure time and the future arrival time or determining whether the vehicle requires any additional energy to travel between the future departure time and the future arrival time based on the amount of energy required and estimated State of Charge (SoC) level associated with the vehicle battery at the future arrival time, scheduling vehicle charging based on the additional energy requirement, determining charging locations in a vehicle route, determining charging rates (or utility rates) at different time slots in a time duration when the vehicle is at the parking and charging location, scheduling vehicle charging when the charging rate is less than a threshold, and/or the like. In addition, the predetermined action may include obtaining inputs associated with renewable energy availability during the time duration, and scheduling vehicle charging when renewable energy is available. In addition, the predetermined action may include determining an energy consumption at the parking and charging location, and scheduling vehicle charging based on the energy consumption. In addition, the predetermined action may include determining a requirement of preconditioning of a vehicle battery, and outputting a notification indicating the requirement of preconditioning. Further, the predetermined action may include predicting a vehicle battery health based on the routine travel behavior, and scheduling a vehicle maintenance based on the vehicle battery health.

The present disclosure discloses a system and method that determines vehicle routine, optimizes vehicle charging, and optimizes energy usage (e.g., enabling consumption of renewable source of energy over non-renewable source, reducing vehicle charging rates, balancing energy consumption for home usage and vehicle charging, etc.). The system further ensures seamless daily routine for the vehicle. In addition, the system enhances user experience of operating the vehicle, and ensures seamless vehicle operation.

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

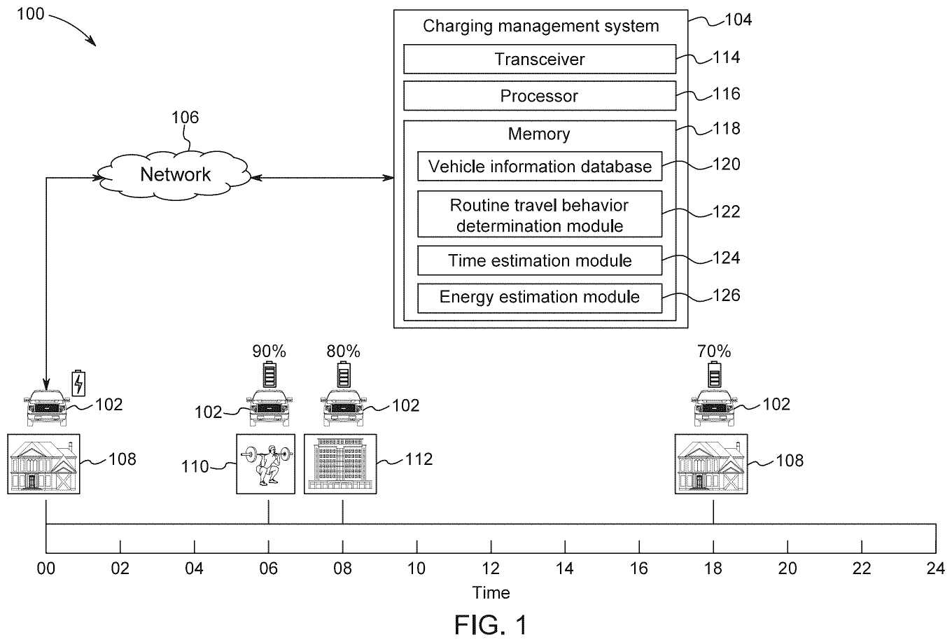

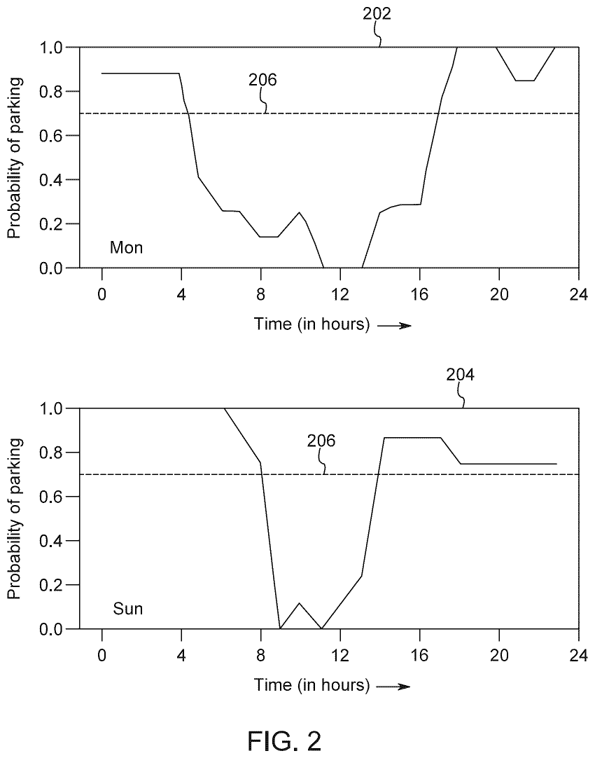

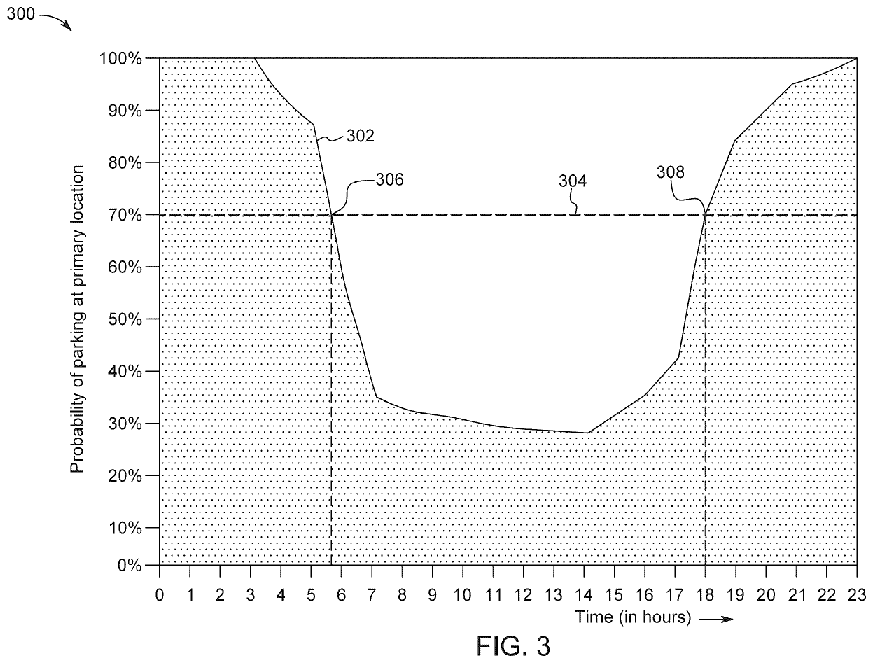

FIG. 1 depicts an example environment 100 in which techniques and structures for providing the systems and methods disclosed herein may be implemented. FIG. 1 will be described in conjunction with FIGS. 2 and 3.

The environment 100 may include a vehicle 102 that may be an Electric Vehicle (EV). The vehicle 102 may take the form of any passenger or commercial vehicle such as a car, a work vehicle, a crossover vehicle, a truck, a van, a minivan, a taxi, a bus, etc. Further, the vehicle 102 may be a manually driven vehicle, and/or may be configured to operate in a fully autonomous (e.g., driverless) mode or a partially autonomous mode.

The environment 100 may further include a charging management system 104 (or system 104) that may be communicatively coupled with the vehicle 102 via a network 106. The network 106, as described herein, illustrates an example communication infrastructure in which the connected devices discussed in various embodiments of this disclosure may communicate. The network 106 may be and/or include the Internet, a private network, public network or other configuration that operates using any one or more known communication protocols such as transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

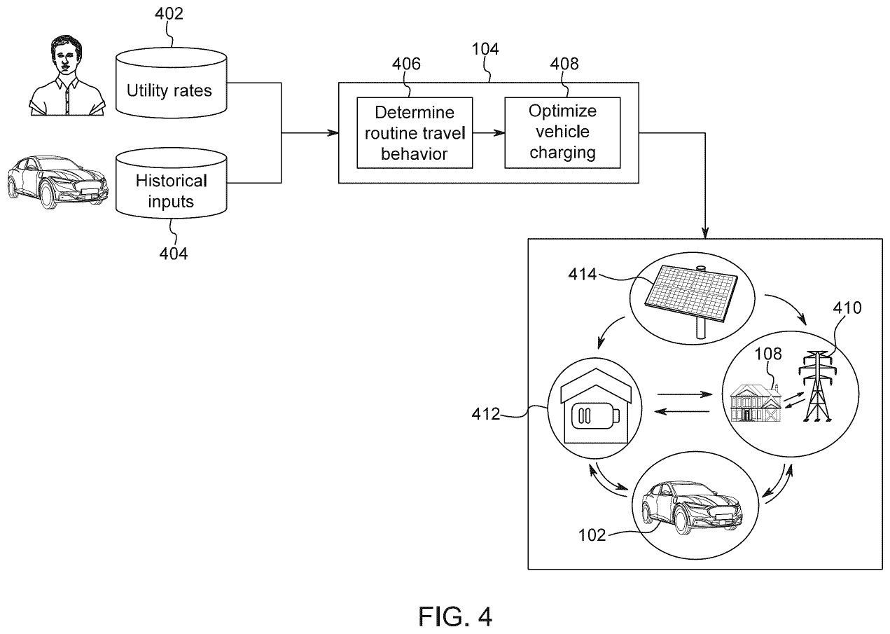

In some aspects, the system 104 may be a part of the vehicle 102. Alternatively, the system 104 may not be a part of the vehicle 102, and may be located outside the vehicle 102. For example, in an exemplary aspect, the system 104 may be hosted on a server, which may be communicatively coupled with the vehicle 102 via the network 106. The system 104 may be configured to obtain and/or store historical inputs (shown as historical inputs 404 in FIG. 4) associated with the vehicle 102, and determine a routine travel behavior of the vehicle 102 based on the historical inputs. Examples of historical inputs associated with the vehicle 102, but are not limited to, trip patterns (e.g., vehicle odometer readings), charging locations/times, SoC level at each recorded time, parking locations/times for the vehicle 102, key on/off alerts, plugin event information, and/or the like.

The vehicle's routine travel behavior may include a typical charging pattern, a parking pattern, and/or a travel pattern associated with the vehicle 102. Specifically, the routine travel behavior may include typical charging locations and associated time durations/times at which the vehicle 102 is charged on each day/week/month, parking locations and associated time durations/times at which the vehicle 102 is parked, travel locations or routes and associated time durations/times for which the vehicle 102 travels on each day/week/month, and/or the like. In addition, the routine travel behavior may include energy usage/consumption pattern (e.g., a State of Charge (SoC) level pattern of a vehicle battery) associated with the vehicle 102. The system 104 may determine the routine travel behavior separately for each day (e.g., weekday or weekend), a week, a month, a season, during special times such as New Year, etc.

As an example, the system 104 may determine routine travel behavior of the vehicle 102 for a 24-hour time duration (e.g., on Monday), which is shown in the form of a graph in FIG. 1. The graph includes X-axis that indicates the time. The graph indicates that the vehicle 102 is parked and charged at user's home 108 from midnight until 6:00 AM. At 6:00 AM, the vehicle 102 departs for a gym 110 and arrives at the gym 110 at 6:15 AM. During this trip from the home 108 to the gym 110, the battery SoC level drops from 100% to 90%. The vehicle 102 then leaves the gym 110 at 7:30 AM and heads to an office location 112, and arrives at the office location 112 at 8:00 AM with an SoC level of 80%. The vehicle 102 then leaves the office location 112 at 5:40 PM and arrives at the home 108 by 6:00 PM with an SoC level of 70%. In some aspects, the graph depicts the vehicle's routine travel behavior for a day (e.g., for Mondays). In this manner, the system 104 determines the routine travel behavior of the vehicle 102 including the locations visited by the vehicle 102, respective arrival and departure times at different locations, SoC pattern, and/or the like.

Responsive to determining the vehicle's routine travel behavior as described above, the system 104 may estimate/predict an amount of energy that may be required/consumed by the vehicle 102 to complete daily routine/schedule, based on the routine travel behavior. The amount of energy may be different for different days, based on the vehicle's routine travel behavior for the specific day. Responsive to estimating the amount of energy, the system 104 may perform one or more predetermined actions to enhance user's convenience of operating the vehicle 102. As an example, the system 104 may automatically schedule vehicle charging and/or vehicle maintenance, to ensure that the vehicle 102 is optimally “ready” (e.g., sufficiently charged) for the vehicle user on each day, when the user departs from the home 108 on the vehicle 102, to prevent interruption in the vehicle's daily routine/schedule.

The system 104 may include a plurality of components including, but not limited to, a transceiver 114, a processor 116, and a memory 118, which may be communicatively coupled with each other. The transceiver 114 may be configured to transmit and receive information or data to/from the vehicle 102 and/or other systems/servers/devices that may be communicatively coupled with the system 104 via the network 106. For example, the transceiver 114 may receive the historical inputs associated with the vehicle 102 directly from the vehicle 102, or from an external server (not shown). In an exemplary aspect, the historical inputs may include trip patterns (e.g., vehicle odometer readings), charging locations/times, SoC level at each recorded time, parking locations/times for the vehicle 102, key on/off alerts, plugin event information, and/or the like.

The processor 116 may be in communication with one or more memory devices in communication with the respective computing systems (e.g., the memory 118 and/or one or more external databases not shown in FIG. 1). The processor 116 may utilize the memory 118 to store programs in code and/or to store data for performing aspects in accordance with the disclosure. The memory 118 may be a non-transitory computer-readable storage medium or memory storing a program code that enables the processor 116 to perform operations in accordance with the present disclosure. The memory 118 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 118 may include a plurality of databases and modules including, but not limited to, a vehicle information database 120, a routine travel behavior determination module 122, a time estimation module 124, an energy estimation module 126, and/or the like. The vehicle information database 120 may store the historical inputs that the system 104 obtains from the vehicle 102 or the external server. The routine travel behavior determination module 122, the time estimation module 124 and the energy estimation module 126 may be stored in the form of computer-executable instructions, and the processor 116 may be configured and/or programmed to execute the stored computer-executable instructions for performing functions/operations in accordance with the present disclosure.

In operation, the transceiver 114 may receive the historical inputs associated with the vehicle 102 directly from the vehicle 102 or the external server, and may store the historical inputs in the memory 118 (e.g., in the vehicle information database 120). The processor 116 may obtain the historical inputs from the transceiver 114 or the vehicle information database 120. Responsive to obtaining the historical inputs, the processor 116 may process and analyze the historical inputs, and determine the routine travel behavior associated with the vehicle 102 based on the historical inputs, by executing the instructions stored in the routine travel behavior determination module 122. As described above, the routine travel behavior may include a charging pattern, a parking pattern, a travel pattern, and/or the like associated with the vehicle 102.

Responsive to determining the routine travel behavior, the processor 116 may determine most visited locations associated with the vehicle 102 for each day, based on the routine travel behavior, by executing the instructions stored in the routine travel behavior determination module 122. The most visited locations may be those locations where the vehicle 102 is parked for a time duration longer than a predefined time duration (e.g., for at least 10-15 minutes), and the frequency of visits to such locations is greater than a predefined frequency threshold (e.g., at least 4-5 times in a week or a month). In some aspects, the most visited locations may include most visited parking and charging locations such as home, public charging stations, etc. In additional aspects, the most visited locations may include other locations visited by the vehicle 102 such as the gym 110, the office location 112, etc. In some aspects, the processor 116 may use a machine learning-based clustering method/module (e.g., Density-Based Spatial Clustering of Applications with Noise (DBSCAN)) to determine the most visited locations. The machine-learning module/processor 116 may receive the recently visited locations (e.g., a few weeks of historical data) associated with the vehicle 102 as input, and may analyze geospatial data of parking and charging to identify the most visited locations.

Responsive to determining the most visited locations, the processor 116 may determine/select a primary parking and charging location from the most visited locations, by executing the instructions stored in the routine travel behavior determination module 122. The primary parking and charging location may be a main location at which the vehicle 102 spends the maximum amount of time in parking and charging on each day, such as the home 108. Responsive to determining the primary parking and charging location, the processor 116 may estimate, by executing the instructions stored in the time estimation module 124, a future departure time from the primary parking and charging location (e.g., for the morning of next day) and a future arrival time at the primary parking and charging location (e.g., for the evening of next day) based on the routine travel behavior. For example, the processor 116 may determine a time at which the vehicle 102 may leave the home 108 in the morning of next day, and a time at which the vehicle 102 may enter the home 108 in the evening of next day, based on the routine travel behavior. In some aspects, the processor 116 may perform the steps described below to estimate the future departure time and the future arrival time. In some aspects, the processor 116 may estimate the future departure time and future arrival time associated with the non-primary parking and charging locations as well.

The processor 116 may first estimate a plurality of probabilities of parking the vehicle 102 at the primary parking and charging location at a plurality of future time slots of next day/week, based on the routine travel behavior, by executing the instructions stored in the routine travel behavior determination module 122. In some aspects, the processor 116 may additionally estimate the plurality of probabilities of parking at any other location on the typical vehicle travel route (e.g., a non-primary parking and charging location). In an exemplary aspect, the processor 116 may use the machine-learning module to analyze the parking and charging data included in the historical inputs associated with the vehicle 102, and predict/generate Parking Probability Profiles (PPP) for the vehicle 102, as depicted in graphs 202 and 204 of FIG. 2. The graph 202 may depict PPP of the vehicle 102 for one day (e.g., a typical Monday), and the graph 204 may depict PPP associated with the vehicle 102 for another day (e.g., a typical Sunday). In the graphs 202, 204, each day may be divided into a fixed number of time slots (e.g., a plurality of future time slots), as depicted in the X-axis of the graphs 202 and 204. The processor 116 measure the probability of parking the vehicle 102 at each timeslot by using any analytical method including, but not limited to, a heuristic method, a time series prediction method, a pattern prediction method, machine learning, large language model (LLM) methods, and/or the like. As an example, the processor 116 may use a heuristic method to measure the chances/probability of a parking event (or parked label) associated with the vehicle 102 for each timeslot on each day and generate the PPP, as depicted in the graphs 202 and 204.

In an exemplary aspect, the graph 202 depicts the PPP for a weekday (e.g., a Monday) and the graph 204 depicts the PPP for a weekend (e.g., a Sunday). The Y-axis of the graphs 202 and 204 depicts a probability of a parking event, or a probability of the vehicle 102 being parked and charged (e.g., at the primary parking and charging location or any other location). As depicted in the graph 202, the vehicle 102 has a lower probability of being parked and charged between 5:00 AM to 5:00 PM on Monday. Further, as depicted in the graph 204, the vehicle 102 has a lower probability of being parked and charged 8 AM and 2 PM on Sunday. For the rest of the time slots/durations, the vehicle 102 has a higher probability of being parked and charged (e.g., at the primary parking and charging location).

Responsive to generating the PPP for the vehicle 102 for each day as described above (and as depicted in the graphs 202, 204 in FIG. 2), the processor 116 may set a first threshold (as depicted by a line 206 in the graphs 202 and 204) to ascertain or detect a parking event associated with the vehicle 102, by executing the instructions stored in the routine travel behavior determination module 122. Stated another way, responsive to generating the PPP for the vehicle 102 for each day, the processor 116 may set the first threshold for the vehicle 102 to distinguish between the time slots/durations when the vehicle 102 is expected to be parked from the time slots/duration when the vehicle 102 is expected to be not parked at the primary parking and charging location (or any other location). In some aspects, the processor 116 may set the first threshold based on the vehicle's routine travel behavior, or specifically based on a vehicle's travel frequency (which may be part of the routine travel behavior), as described later in the description below.

Responsive to setting the first threshold, the processor 116 may compare each probability included in the graphs 202, 204 with the first threshold. Based on the comparison, the processor 116 may determine those time durations/slots on each day at which the probability of parking the vehicle 102 at the primary parking and charging location may be greater than the first threshold. For example, based on the comparison of the plurality of probabilities included in the graph 202 with the first threshold, the processor 116 may determine that the vehicle 102 is expected to park at the primary parking and charging location between 5 PM to 5 AM on Mondays (i.e., at a “first time slot”), as the respective probabilities at this first time slot is greater than the first threshold. As another example, based on the comparison of the plurality of probabilities included in the graph 204 with the first threshold, the processor 116 may determine that the vehicle 102 is expected to park at the primary parking and charging location between 2 PM to 8 AM on Sundays (i.e., the first time slot), as the respective probabilities at this time slot is greater than the first threshold. In this manner, the processor 116 is configured to determine that the vehicle 102 is expected to be parked at the primary parking and charging location during the first time slot (or a first future time slot) when the probabilities associated with the first time slot are greater than the first threshold.

As shown in the graphs 202, 204, when the processor 116 sets the first threshold as 70%, the processor 116 may determine that the vehicle 102 is expected to be present/parked at the primary parking and charging location between 12:00 AM to 5:00 AM on a weekday, as the probabilities of parking are greater than 70% during this time slot. Similarly, the processor 116 may determine that the vehicle 102 is expected to be present/parked at the primary parking and charging location between 5:00 PM to 12:00 AM on a weekday, as the associated probabilities during this time slot are greater than 70%. The graphs 202 and 204 indicate that the vehicle 102 is mostly parked at the primary parking and charging location (e.g., the home 108) on weekend as compared to weekdays.

In further aspects, the processor 116 may be configured to dynamically update the first threshold for the vehicle 102 as more vehicle data (i.e., more historical inputs) associated with the vehicle 102 is obtained, to accurately ascertain/detect the parking event for the vehicle 102, by executing the instructions stored in the routine travel behavior determination module 122. The processor 116 may set and/or dynamically adjust the first threshold based on an expected travel frequency (or vehicle travel pattern/behavior) of the vehicle 102 for a plurality of future time slots, which the processor 116 may determine or estimate based on the routine travel behavior. In an exemplary aspect, the processor 116 may set a high first threshold for commercial vehicles as compared to personal vehicles, as the travel frequency associated with commercial vehicles is expected to be greater than the travel frequency of personal vehicles. The travel frequency, as described in the present disclosure, may mean a count of time durations or a total amount of time duration in a day for which the vehicle 102 is traveling and is not parked/getting charged. A person ordinarily skilled in the art may appreciate that a commercial vehicle is expected to travel more and get parked less; therefore, the first threshold indicating a probability of vehicle parking/charging event is set high for the commercial vehicle. On the other hand, a personal vehicle is expected to travel less and get parked more (as compared to a commercial vehicle); therefore, the first threshold indicating the probability of vehicle parking/charging event is set relatively lower for the personal vehicle.

In some aspects, the processor 116 may use the machine-learning module to select an optimal first threshold based on the travel frequency of the vehicle 102, to accurately detect the parking event for the vehicle 102 and enhance user experience. Specifically, the processor 116 may determine the travel frequency of the vehicle 102, categorize the vehicle 102 as a “frequent traveling vehicle” or a “non-frequent traveling vehicle”, based on the travel frequency, and select/set the first threshold based on the categorization. In some aspects, the processor 116 may adjust or set different first thresholds for different days, based on the travel frequency (or trip pattern) of the vehicle 102 on each day. For example, the processor 116 may set a high first threshold for weekdays as compared to weekends, as the vehicle 102 is expected to travel more on weekdays.

In further aspects, responsive to setting/adjusting the first threshold, the processor 116 may estimate a future departure time from the primary parking and charging location and a future arrival time at the primary parking and charging location for the next day for the vehicle 102, based on the first threshold. In some aspects, the processor 116 may use the machine-learning module to analyze the PPP associated with the next day to estimate the future departure time and the future arrival time for the vehicle 102, from a plurality of future time slots for the next day. A visualization of a result of PPT analysis is shown in FIG. 3. Specifically, FIG. 3 depicts a graph 300 in which horizontal axis or X-axis represents the plurality of future time slots for the next day, and the vertical axis or the Y-axis represents the probability of parking at the primary parking and charging location for the vehicle 102.

In the graph 300, a curve 302 represents a parking behavior/pattern at the primary parking and charging location for the vehicle 102 (or the probabilities of the vehicle 102 getting parked at different times of the next/future day), and a horizontal line 304 represents the first threshold. The processor 116 may estimate the future departure time and the future arrival time based on the first threshold (i.e., the line 304) and the parking behavior/pattern (i.e., the curve 302). For example, a first intersection point 306 of the curve 302 and the horizontal line 304 represents the expected future departure time from the primary parking and charging location, and a next intersection point 308 of the curve 302 and the horizontal line 304 represents the expected future arrival time at the primary parking and charging location. The time duration between the future departure time and the future arrival time is referred to as a “trip window” or “trip time duration” in which the vehicle 102 may be traveling to one or more locations. For example, based on the graph 300, the processor 116 may determine that the vehicle 102 may leave the primary parking and charging location around 5:30-5:45 AM and may arrive back at the primary parking and charging location at 6:00 PM.

Responsive to estimating the future departure time and the future arrival time as described above, the processor 116 may estimate, by executing the instructions stored in the energy estimation module 126, an amount of energy that may be required by the vehicle 102 to travel between the future departure time and the future arrival time (or on the trip window), based on the routine travel behavior. Stated another way, the processor 116 may estimate the expected amount of energy required by the vehicle 102 to travel in the trip window, or complete the daily routine/activities. In some aspects, the processor 116 may analyze the historical inputs associated with the vehicle 102 by using regression, ML-based or heuristic models, and calculate the amount of energy required to travel between multiple locations in a day (e.g., in the trip window) based on the analysis of the historical inputs. In some aspects, the processor 116 may further calculate a summation of the amounts of energies required for each day of a week, and determine a total amount of energy required by the vehicle 102 for a complete week based on the summation.

Responsive to estimating the amount of energy required by the vehicle 102 on the trip window, the processor 116 may perform a predetermined action based on the estimated amount of energy. In one exemplary aspect, to perform the predetermined action, the processor 116 may estimate a first SoC of a vehicle battery at the future departure time based on the routine travel behavior, and predict a second SOC associated with the vehicle battery at the future arrival time based on the first SoC and the estimated amount of energy. The processor 116 may then compare the second SoC with a second threshold, and determine that the vehicle 102 may require additional energy (over and above the first SoC level) to travel in the trip window (e.g., between the future departure time and the future arrival time) when the second SOC may be less than the second threshold. Stated another way, the processor 116 may determine whether the vehicle 102 (that may be getting charged at the primary parking and charging location) may be able to complete the trip in the trip window without requiring any additional charge, or the vehicle 102 may require additional charging to complete the trip. Responsive to the determination that the vehicle 102 may require additional energy, the processor 116 may output a first notification on a user interface (e.g., on a vehicle Human-Machine Interface (HMI), a user device, and/or the like), indicating the requirement of additional energy/charging for the vehicle 102. In some aspects, the processor 116 may additionally recommend charging locations/stations (e.g., other than the primary parking and charging location) to charge the vehicle 102, as part of the first notification. In additional aspects, the processor 116 may estimate an additional amount of energy that should get charged at the vehicle 102, and the processor 116 may output information associated with the additional amount of energy as part of the first notification, so that the vehicle user may accordingly charge the vehicle 102 or the vehicle 102 may automatically get charged based on the additional amount of energy.

In another exemplary aspect, to perform the predetermined action, the processor 116 may determine a requirement of preconditioning of the vehicle battery when the vehicle is located at the primary parking and charging location, based on the routine travel behavior (and the estimated amount of energy), and may enable the vehicle 102 to perform the required preconditioning before the vehicle 102 departs from the home 108. In some aspects, the predetermined action may include transmitting a command/instruction to the vehicle 102 to perform the preconditioning and time duration to precondition the battery. In other aspects, the predetermined action may include outputting a second notification to the vehicle HMI and/or the user device, indicating a requirement of battery preconditioning, and a recommended time duration to precondition the battery.

In some aspects, the predetermined action may further include optimizing and scheduling vehicle charging. The details of optimizing and scheduling the vehicle charging are described below in conjunction with FIG. 4.

FIG. 4 depicts an example process to optimize vehicle charging, in accordance with the present disclosure. FIG. 4 specifically depicts a scenario where the system 104 (or the processor 116) obtains utility rates 402 (associated with a utility power source 410 or grid 410) along with historical inputs 404 associated with the vehicle 102, via the transceiver 114. Responsive to receiving the historical inputs 404, the processor 116 may determine the routine travel behavior (indicated by a block 406), as described above in conjunction with FIGS. 1-3. Responsive to determining the routine travel behavior, the processor 116 may optimize vehicle charging (indicated by a block 408) based on the routine travel behavior and the utility rates 402. The details of the optimization of vehicle charging may be understood as follows.

In some aspects, the processor 116 may determine a time duration for which the vehicle 102 may be parked at the primary parking and charging location, based on the estimated future departure time and the future arrival time, as described above. The processor 116 may then determine a plurality of charging rates of charging the vehicle 102 at a plurality of time slots in the time duration based on the utility rates 402, and perform the predetermined action based on the plurality of charging rates. In this case, the predetermined action may include scheduling the vehicle charging based on the plurality of charging rates.

As an example, the processor 116 may determine that the vehicle 102 may be at the home 108 between 6:00 PM to 6:00 AM. The processor 116 may further determine the utility rates at different time slots between 6:00 PM to 6:00 AM, and schedule the vehicle charging at those time slots when the utility rates are less (e.g., less than a third threshold). The processor 116 may then output a notification to the user interface (e.g., on the user device or the vehicle HMI) to charge the vehicle 102 at the scheduled time slots or may cause the vehicle 102 to automatically charge at the scheduled time slots. In the latter case, the processor 116 may output a command signal/notification to the vehicle 102 at the scheduled time slots, to cause automatic vehicle charging.

In further aspects, the processor 116 may obtain inputs associated with renewable energy availability (e.g., from a server) during the time duration (e.g., between 6:00 PM to 6:00 AM), and perform the predetermined action based on the renewable energy availability. In this case, the predetermined action may include scheduling the vehicle charging when renewable energy is available. As an example, the processor 116 may obtain weather condition information, solar panel 414 capacity, etc. from an external server (not shown), and may estimate solar energy availability based on the weather condition information and the solar panel 414 capacity. The processor 116 may schedule the vehicle charging when renewable energy is available, thereby maximizing the use of renewable energy for vehicle charging.

In further aspects, the processor 116 may obtain inputs associated with historical energy consumption of the primary parking and charging location (e.g., the home 108), and estimate energy consumption at the primary parking and charging location during the time duration (e.g., between 6:00 PM to 6:00 AM) based on the inputs. The processor 116 may perform the predetermined action based on the energy consumption at the primary parking and charging location. In this case, the predetermined action may include scheduling the vehicle charging based on the energy consumption at the primary parking and charging location. For example, the processor 116 may schedule the vehicle charging when the energy consumption at the home 108 is expected to be less (e.g., less than a fourth threshold). In some aspects, the processor 116 may determine optimal home settings (e.g., heating, lighting, security system settings at the primary parking and charging location) based on the vehicle charging schedule for efficiency and convenience, and cause the home 108 to implement the determined home setting during the time duration. In an exemplary aspect, the processor 116 may balance the energy consumption at the home 108 and the vehicle charging such that the vehicle 102 is charged to a desired SoC level at the future departure time. In further aspects, the processor 116 may schedule the vehicle charging based on a vehicle battery 412 specification/capacity/SoC/charging rate, etc.

In addition, the processor 116 may facilitate exchange of energy between the vehicle 102, the home 108, the utility power source 410, etc. based on the routine travel behavior. In some aspects, the vehicle 102 may be used as a temporary storage device, and excess energy may be stored in the vehicle's battery during times of low demand and then fed back into the grid 410 during peak demand. In addition, the energy may be transferred from the vehicle 102 to the home 108 when the vehicle 102 may not be in use. In some aspects, the processor 116 may facilitate the exchange of energy from/to the vehicle 102 based on the vehicle battery 412 specification/capacity/SoC/charging rate, etc.

Further, the processor 116 may be configured to predict a vehicle battery health based on the routine travel behavior, and automatically schedule vehicle maintenance based on the vehicle battery health. In some aspects, the processor 116 may schedule the vehicle maintenance based on the routine travel behavior such that the maintenance may not interrupt the vehicle's travel schedule.

The vehicles 102 and the system 104 implement and/or perform operations, as described here in the present disclosure, in accordance with the owner manual and safety guidelines. In addition, any action taken by the operator associated with the vehicle 102 based on the notifications/recommendations provided by the system 104 should comply with all the rules specific to the location and operation of the vehicle 102 (e.g., Federal, state, country, city, etc.). The notifications/recommendations, as provided by the system 104, should be treated as suggestions and only followed according to any rules specific to the location and operation of the vehicles 102.

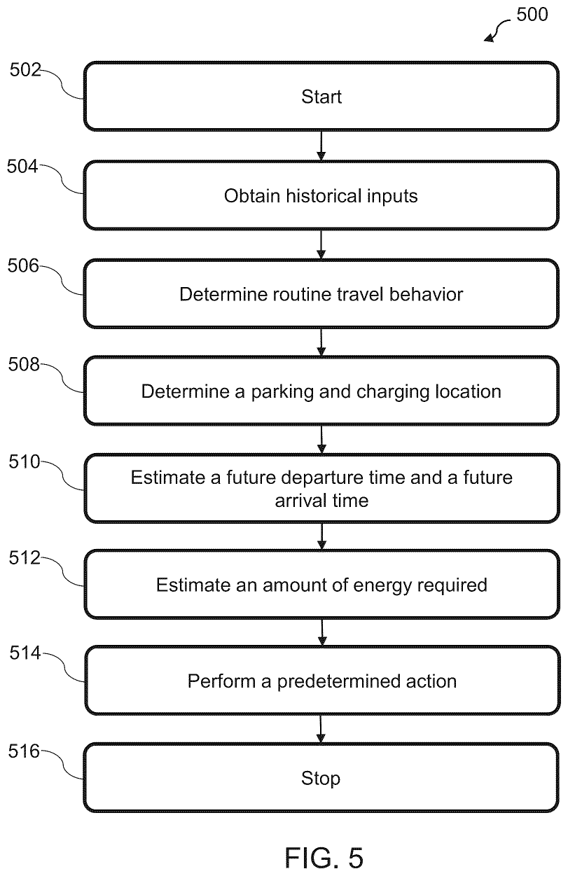

FIG. 5 depicts a flow diagram of an example vehicle charging method 500 in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 500 starts at step 502. At step 504, the method 500 may include obtaining, by the processor 116, historical inputs associated with the vehicle 102. The historical inputs may include trip patterns (e.g., vehicle odometer readings), charging locations/times, parking locations/times, and/or the like for the vehicle 102. At step 506, the method 500 may include determining, by the processor 116, a routine travel behavior of the vehicle 102 based on the historical inputs. The routine travel behavior may include a charging pattern, a parking pattern, and a travel pattern associated with the vehicle 102.

At step 508, the method 500 may include determining, by the processor 116, the parking and charging location (e.g., the primary parking and charging location) based on the routine travel behavior. In some aspects, the processor 116 may determine most visited locations and respective visited time slots based on the routine travel behavior (which may include the most visited parking and charging locations), and may determine the parking and charging location from the most visited locations. The routine travel behavior may further include energy consumption pattern (or SoC) levels associated with the vehicle 102 (e.g., SoC levels at different times and different days).

At step 510, the method 500 may include estimating, by the processor 116, the future departure time from the parking and charging location and the future arrival time at the parking and charging location based on the routine travel behavior. At step 512, the method 500 may include estimating, by the processor 116, an amount of energy required by the vehicle 102 to travel between the future departure time and the future arrival time, based on the routine travel behavior. At step 514, the method 500 may include performing, by the processor 116, the predetermined action based on the estimated amount of energy. Examples of the predetermined actions are described above in conjunction with FIGS. 1-4.

At step 516, the method 500 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
a transceiver configured to receive historical inputs associated with a vehicle; and
a processor communicatively coupled to the transceiver, wherein the processor is configured to:
determine a routine travel behavior of the vehicle based on the historical inputs, wherein the routine travel behavior comprises a charging pattern, a parking pattern, and a travel pattern associated with the vehicle;
determine a parking and charging location associated with the vehicle based on the routine travel behavior;
estimate a future departure time from the parking and charging location and a future arrival time at the parking and charging location of the vehicle based on the routine travel behavior;
estimate an amount of energy required by the vehicle to travel between the future departure time and the future arrival time, based on the routine travel behavior; and
perform a predetermined action based on the amount of energy.

2. The system of claim 1, wherein the processor is further configured to:
determine most visited locations and respective visited time slots associated with the vehicle based on the routine travel behavior, wherein the most visited locations comprise most visited parking and charging locations; and
determine the parking and charging location from the most visited locations.

3. The system of claim 2, wherein the processor is further configured to estimate a plurality of probabilities of parking the vehicle at the parking and charging location at a plurality of future time slots based on the routine travel behavior.

4. The system of claim 3, wherein the processor is further configured to:
set a first threshold to ascertain a parking event at the parking and charging location;
determine that a probability, of the plurality of probabilities, at a first future time slot, of the plurality of future time slots, is greater than the first threshold; and
determine that the vehicle is expected to park at the parking and charging location during the first future time slot based on a determination that the probability is greater than the first threshold.

5. The system of claim 4, wherein the processor is further configured to detect a travel frequency associated with the vehicle in the plurality of future time slots, and wherein the travel frequency is part of the routine travel behavior.

6. The system of claim 5, wherein the processor sets the first threshold based on the travel frequency.

7. The system of claim 6, wherein the processor is further configured to estimate the future departure time and the future arrival time at the parking and charging location based on the first threshold.

8. The system of claim 7, wherein to perform the predetermined action, the processor is further configured to:
estimate a first State of Charge (SOC) level of a vehicle battery at the future departure time from the parking and charging location based on the routine travel behavior; and
predict a second SOC level of the vehicle battery at the future arrival time based on the first SOC and the amount of energy.

9. The system of claim 8, wherein to perform the predetermined action, the processor is further configured to:
compare the second SOC with a second threshold;
determine that the vehicle requires additional energy to travel between the future departure time and the future arrival time when the second SOC is less than the second threshold; and
output a first notification comprising an indication of a requirement of additional energy.

10. The system of claim 1, wherein the processor is further configured to:
determine a time duration for which the vehicle is at the parking and charging location, based on the future departure time and the future arrival time;
determine a plurality a charging rates of charging the vehicle at a plurality of time slots in the time duration; and
perform the predetermined action based on the plurality of charging rates, wherein the predetermined action comprises scheduling vehicle charging based on the plurality of charging rates.

11. The system of claim 10, wherein the processor is further configured to:
obtain inputs associated with a renewable energy availability during the time duration; and
perform the predetermined action based on the renewable energy availability, wherein the predetermined action comprises scheduling vehicle charging when renewable energy is available.

12. The system of claim 10, wherein the processor is further configured to:
obtain inputs associated with historical energy consumption associated with the parking and charging location;
estimate an energy consumption at the parking and charging location during the time duration based on the inputs; and
perform the predetermined action based on the energy consumption at the parking and charging location, wherein the predetermined action comprises scheduling vehicle charging based on the energy consumption at the parking and charging location.

13. The system of claim 1, wherein the processor is further configured to:
determine a requirement of preconditioning of a vehicle battery when the vehicle is located at the parking and charging location based on the routine travel behavior; and
perform the predetermined action based on the requirement of preconditioning, wherein the predetermined action comprising outputting a second notification comprising an indication of the requirement of preconditioning.

14. The system of claim 1, wherein the processor is further configured to:
predict a vehicle battery health based on the routine travel behavior; and
schedule a vehicle maintenance based on the vehicle battery health.

15. The system of claim 14, wherein the processor is further configured to schedule the vehicle maintenance based on the routine travel behavior.

16. A method comprising:
determining, by a processor, a routine travel behavior of a vehicle based on historical inputs associated with the vehicle, wherein the routine travel behavior comprises a charging pattern, a parking pattern, and a travel pattern associated with the vehicle;
determining, by the processor, a parking and charging location associated with the vehicle based on the routine travel behavior;
estimating, by the processor, a future departure time from the parking and charging location and a future arrival time at the parking and charging location of the vehicle based on the routine travel behavior;
estimating, by the processor, an amount of energy required by the vehicle to travel between the future departure time and the future arrival time, based on the routine travel behavior; and
performing, by the processor, a predetermined action based on the amount of energy.

17. The method of claim 16 further comprising:
determining most visited locations and respective visited time slots associated with the vehicle based on the routine travel behavior, wherein the most visited locations comprise most visited parking and charging locations; and
determining the parking and charging location from the most visited locations.

18. The method of claim 17 further comprising estimating a plurality of probabilities of parking the vehicle at the parking and charging location at a plurality of future time slots based on the routine travel behavior.

19. The method of claim 18 further comprising:
setting a threshold to ascertain a parking event at the parking and charging location;
determining that a probability, of the plurality of probabilities, at a first future time slot, of the plurality of future time slots, is greater than the threshold; and
determining that the vehicle is expected to park at the parking and charging location during the first future time slot based on a determination that the probability is greater than the threshold.

20. A non-transitory computer-readable storage medium having instructions stored thereupon which, when executed by a processor, cause the processor to:
determine a routine travel behavior of a vehicle based on historical inputs associated with the vehicle, wherein the routine travel behavior comprises a charging pattern, a parking pattern, and a travel pattern associated with the vehicle;
determine a parking and charging location associated with the vehicle based on the routine travel behavior;
estimate a future departure time from the parking and charging location and a future arrival time at the parking and charging location of the vehicle based on the routine travel behavior;
estimate an amount of energy required by the vehicle to travel between the future departure time and the future arrival time, based on the routine travel behavior; and
perform a predetermined action based on the amount of energy.
